(19) United States
(12) Patent Application Publication
(10) Pub. No.: US 2014/0164378 A1
(43) Pub. Date: Jun. 12, 2014

(54) SOURCE RECORD MANAGEMENT FOR MASTER DATA

(71) Applicant: INTERNATIONAL BUSINESS MACHINES CORPORATION, Armonk, NY (US)

(72) Inventors: ANDREW KEITH LEVANDOSKI, Cary, NC (US); John Frankin Murray, Montgomery, AL (US); Ramanakumar Natarajan, Boca Raton, FL (US); Timothy Wayne Owings, Lake Worth, FL (US); Ravindran Yelchur, Delray Beach, FL (US)

(73) Assignee: International Business Machines Corporation, Armonk, NY (US)

(21) Appl. No.: 13/710,629

(22) Filed: Dec. 11, 2012

(51) Int. Cl. G06F 17/30

(52) U.S. Cl. CPC G06F 17/30598
USPC 707/737

(57) ABSTRACT

A method, system, and computer program product for source record management for master data are provided in the illustrative embodiments. A set of data records is received from a set of data sources. A first subset of data records received from a first data source is pre-processed. A match engine is requested to match a data record from the first subset using at least one record in the master data repository, the requesting resulting in a set of matched data records. The set of matched data records, which includes a first data record in the first subset and a second data record in a second subset, is post-processed. The second subset is received from a second data source. The first data record is assigned to a group of records, together representing the entity as a master data record.

### TECHNICAL FIELD

The present invention relates generally to a method, system, and computer program product for managing data records (records) in a data processing system. More particularly, the present invention relates to a method, system, and computer program product for source record management for master data using data records about an entity received from data sources (sources).

### BACKGROUND

An entity is a subject of a data record. For example, a place of business, such as a local pizza shop, is an entity, whose name, address, phone number, fax number, number of employees, year of establishment, and many other attributes form a data record about the entity. Similarly, a person, a location, an organization, and a system are also other example entities that can be the subjects of data records.

Different data sources can provide different data records about the same entity. For example, a data source related to the post office can provide one or more data records that contain the mailing address of the example pizza shop entity but not the phone number, whereas a yellow-pages data source can provide one or more data records that contain the phone number and the physical address of the pizza shop entity, which may be different from the mailing address for the pizza shop provided by the post office data source.

Any number of data sources can provide data records about an entity. The data records from the various data sources may pertain to the same entity but may not necessarily overlap in all respects. Furthermore, not all data sources are created equal. For example, different data sources may not be equally reliable, updated on the same schedule, or updated using the same updates. For example, at least in some cases, a verified data source that requires a subscription is likely to have more or newer information than an unverified public data source. Another example data source may only regularly update the phone numbers but not the business name even if the business has changed names.

### SUMMARY

The illustrative embodiments provide a method, system, and computer program product for source record management. In at least one embodiment, a method for source record management for master data is provided. The method includes a computer receiving a set of data records from a set of data sources for updating records in a master data repository. The method further includes the computer pre-processing a first subset of data records from the set of data records, the first subset of data records being received from a first data source in the set of data sources. The method further includes the computer requesting a match engine to match a data record from the first subset of data records using at least one record in the master data repository, the requesting resulting in a set of matched data records. The method further includes the computer post-processing the set of matched data records, wherein the set of matched data records includes a first data record in the first subset of data records and a second data record in a second subset of data records from the set of data records, the second subset of data records being received from a second data source in the set of data sources. The method further includes the computer assigning the first data record to a group of records, the group of records and the first data record together representing the entity as a master data record in the master data repository.

In at least one embodiment, a computer program product for source record management for master data is provided. The computer program product includes one or more computer-readable tangible storage devices. The computer program product further includes program instructions, stored on at least one of the one or more storage devices, to receive a set of data records from a set of data sources for updating records in a master data repository. The computer program product further includes program instructions, stored on at least one of the one or more storage devices, to pre-process a first subset of data records from the set of data records, the first subset of data records being received from a first data source in the set of data sources. The computer program product further includes program instructions, stored on at least one of the one or more storage devices, to request a match engine to match a data record from the first subset of data records using at least one record in the master data repository, the requesting resulting in a set of matched data records. The computer program product further includes program instructions, stored on at least one of the one or more storage devices, to post-process the set of matched data records, wherein the set of matched data records includes a first data record in the first subset of data records and a second data record in a second subset of data records from the set of data records, the second subset of data records being received from a second data source in the set of data sources. The computer program product further includes program instructions, stored on at least one of the one or more storage devices, to assign the first data record to a group of records, the group of records and the first data record together representing the entity as a master data record in the master data repository. In at least one embodiment, a computer system for source record management for master data is provided.

The computer system includes one or more processors, one or more computer-readable memories and one or more computer-readable tangible storage devices. The computer system further includes program instructions, stored on at least one of the one or more storage devices for execution by at least one of the one or more processors via at least one of the one or more memories, to receive a set of data records from a set of data sources for updating records in a master data repository. The computer system further includes program instructions, stored on at least one of the one or more storage devices for execution by at least one of the one or more processors via at least one of the one or more memories, to pre-process a first subset of data records from the set of data records, the first subset of data records being received from a first data source in the set of data sources. The computer system further includes program instructions, stored on at least one of the one or more storage devices for execution by at least one of the one or more processors via at least one of the one or more memories, to request a match engine to match a data record from the first subset of data records using at least one record in the master data repository, the requesting resulting in a set of matched data records. The computer system further includes program instructions, stored on at least one of the one or more storage devices for execution by at least one of the one or more processors via at least one of the one or more memories, to post-process the set of matched data records, wherein the set of matched data records includes a first data record in the first subset of data records and a second data record in a second subset of data records from the set of data records, the second subset of data records being received from a second data source in the set of data sources. The computer system further includes program instructions, stored on at least one of the one or more storage devices for execution by at least one of the one or more processors via at least one of the one or more memories, to assign the first data record to a group of records, the group of records and the first data record together representing the entity as a master data record in the master data repository.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of example functionality of an application for source record management for master data in accordance with an illustrative embodiment;

FIG. 4 depicts a partial block diagram of an example application for source record management for master data in accordance with an illustrative embodiment;

FIG. 5 depicts a block diagram of an example configuration for source record management for master data in accordance with an illustrative embodiment;

FIG. 6 depicts a block diagram of presenting entity information using a group of records in accordance with an illustrative embodiment;

FIG. 7 depicts a flowchart of an example process for source record management for master data in accordance with an illustrative embodiment; and

FIG. 8 depicts a flowchart of an example process of assigning keys to post-processed records in accordance with an illustrative embodiment.

### DETAILED DESCRIPTION

The illustrative embodiments recognize that a data processing environment has to collect, merge, combine, discard, retire, and transform data from a variety of sources. For example, as businesses transform older systems, they need a mechanism to relate together various systems with similar information about common entities, to produce a trusted version of the information that will become the new master data for the new systems.

As another example, the illustrative embodiments also recognize that a similar need exists when a data processing environment consumes data from several data sources. When a data source changes, or when data from a data source changes, those changes have to be assimilated into the existing master data.

The illustrative embodiments recognize that the assimilation process cannot be a simplistic matching of data records just to find duplicates. The illustrative embodiments recognize that often data records that are not exact duplicates of one another are still associated with a common entity in some manner. Therefore, a matching operation performed using an existing matching application may not be sufficient or suitable for modifying the master data with the changed data record, changed data source, or both.

The illustrative embodiments used to describe the invention generally address and solve the above-described problems and other problems related to the limitations of presently available data matching technologies. The illustrative embodiments provide a method, system, and computer program product for source record management for master data.

The illustrative embodiments provide certain capabilities to manage data records received from a set of data sources. For example, an embodiment is able to recognize different data records pertaining to the same entity in the data stream of a single data source. The embodiment is further able to treat different data records pertaining to the same entity in the data stream of the single data source according to defined rules, logic, or policies. For example, different data records of the same entity may be acceptable when present in one data source's data stream but not when present in another data source's data stream.

Another embodiment is also able to recognize different data records pertaining to the same entity in the data stream of a different data sources. The embodiment is further able to treat such different data records according to other defined rules, logic, or policies. For example, data records of the same entity from one data source may be preferable or more reliable than those from another data source.

Another embodiment further performs a grouping of data records according to the recognition and treatment of data records related to an entity. The embodiment thus groups data records in the various data streams as being related to one another because they are related to the same entity. The embodiment assigns a key to a group of such related data records. The embodiment treats the group of data records having a common key together, such as for persisting in a master data repository, or presentation of information about the entity.

For example, even though no one data record from any one data source may include all the information about the entity, the group of data records may provide more complete information than any single data record. Being able to identify the data source that provides a particular data record is important for many reasons, including some example reasons, such as reliability, described above. The illustrative embodiments recognize that combining all such data records, using existing methodologies, so that one master record can include all the information, causes a loss of the identifying information about the sources that provided the constituent data records.

An embodiment recognizes that the identity of a data source can be important when presenting certain attributes of information about an entity. For example, a revenue projection attribute of an entity may be more accurate coming from a securities-related data source rather than a news-related data source. An embodiment preserves the source identifiers of the data sources of the constituent data records in a group.

An embodiment generates a view of the entity using the data records that are included in a group according to a common key. The view can be presented in a data source agnostic manner, or with source identifying information corresponding to certain attributes of the entity information in the view as needed.

As an embodiment detects differences in one or more data records from one or more data sources, the embodiment determines whether the changed data record still belongs in the group assigned to the previous version of the data record. If the amount or nature of the differences exceeds certain thresholds, an embodiment can change the group of the changed data record.

Another embodiment can assign the same key to the changed data record as was assigned to the previous data record, but may assign different keys to the other constituent data records of the group. An embodiment may also create new groups with new keys if the changes in the data records so warrant.

As an example, an embodiment can determine whether to assign the same or a different key to the changed data record or another data record based on logic, rules, or policies. The logic, rule, or policies can include thresholds or levels for measuring the changes, defaults or baselines for detecting and assessing the changes, conditions or tests for using or discarding the changes, or a combination thereof.

The illustrative embodiments are described with respect to certain data records and data sources only as examples. Such data records and data sources or their example attributes are not intended to be limiting to the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

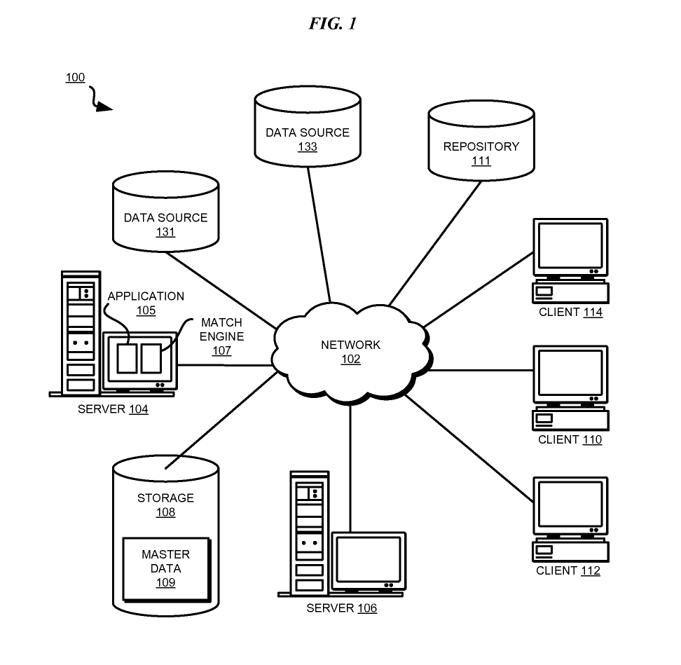

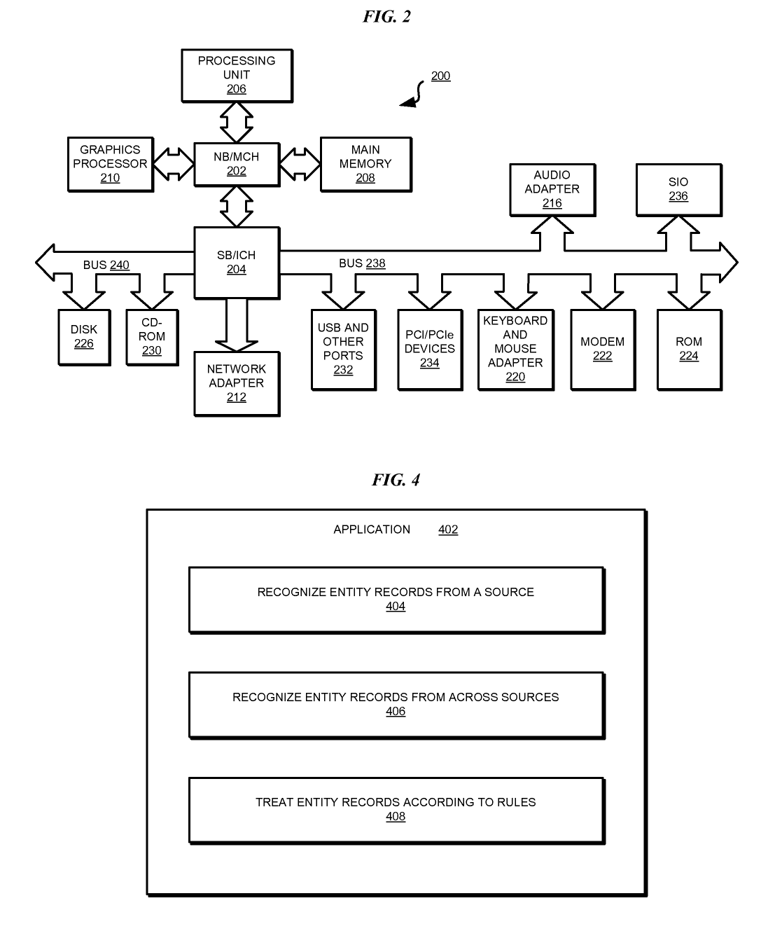

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114, may contain data and may have software applications or software tools executing thereon.

Only as an example, and without implying any limitation to such architecture, FIG. 1 depicts certain components that are usable in an example implementation of an embodiment. For example, data sources 131 and 133 are two example data sources, of which there can be any number present in a given implementation. Application 105 in server 104 is an implementation of an embodiment described herein. Application 105 operates in conjunction with match engine 107. Match engine 107 may be, for example, an existing application capable of matching data records for finding duplicates, and may be modified or configured to operate in conjunction with application 105 to perform an operation according to an embodiment described herein. Storage 108 includes master data 109 and may be regarded as a master data repository according to an embodiment. Repository 111 is any suitable data repository for storing additional data described herein. Repository 111 and storage 108 may use same or different hardware or software components within the scope of the illustrative embodiments.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 and match engine 107 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

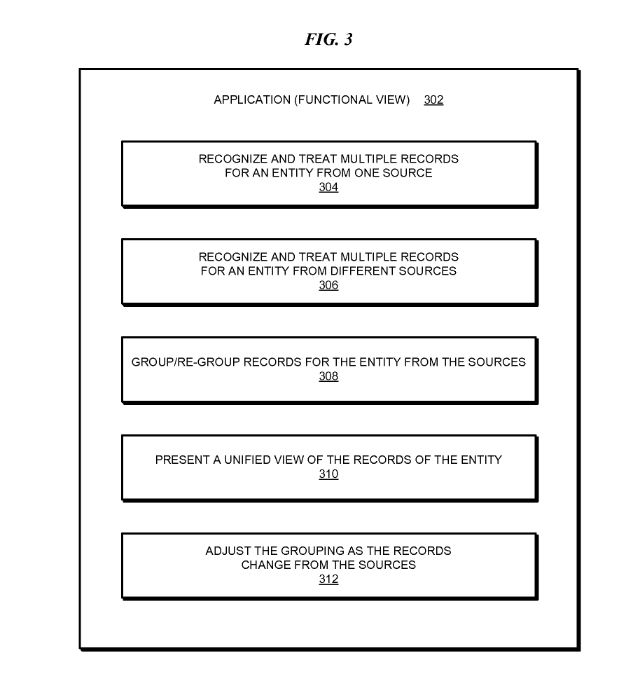

With reference to FIG. 3, this figure depicts a block diagram of example functionality of an application for source record management for master data in accordance with an illustrative embodiment. Application 302 is an example of application 105 in FIG. 1.

Application 302 includes functionality 304 for recognizing and treating multiple records received for one entity from a single data source. Functionality 306 recognizes and treats multiple records received for one entity from a set of different data sources.

Application 302 performs grouping or re-grouping of data records pertaining to a common entity using functionality 308. Functionality 310 presents a unified view of a group or sub-group of records pertaining to an entity. Functionality 312 adjusts the grouping of records as one or more records, sources, or a combination thereof, change.

With reference to FIG. 4, this figure depicts a partial block diagram of an example application for source record management for master data in accordance with an illustrative embodiment. Application 402 depicts example components usable for providing some of the functionality depicted in application 302 in FIG. 3.

For example, in support of functionality 304 in FIG. 3, component 404 recognizes records pertaining to an entity in the data stream of a single source. Further in support of functionality 304 in FIG. 3, component 408 treats, processes, and otherwise manipulates the recognized records according to rules, logic, or policies, as described by way of examples elsewhere in this disclosure.

In support of functionality 306 in FIG. 3, component 406 recognizes records pertaining to an entity in the data streams of different sources. Further in support of functionality 306 in FIG. 3, component 408 treats, processes, and otherwise manipulates the recognized records according to rules, logic, or policies, as described by way of examples elsewhere in this disclosure.

Within the scope of the illustrative embodiments, a record is a duplicate of another record if the two records pertain to the same entity, even if the two records include data about the entity that is not identical in all respects. In an example operation, component 408 may use an example rule to allow duplicate records of an entity from a particular source to be processed into the master data. Another rule may cause component 408 to prevent a duplicate record about an entity from processing into the master data.

An example policy may cause component 408 to decide which record to reject when the duplicate records are not exact duplicates of one another. Another example logic may cause component 408 to multiple records pertaining to the entity before they are processed into the master data. A rule may define how to merge certain data from certain records. A policy may define a preference order amongst the data sources, amongst similar records of an entity, or both. Certain business rules may cause component 408 to transform a record before the record is matched with other records for finding duplicate records.

These example rules, policies, or logic are not intended to be limiting on the illustrative embodiments. Many other similar rules, policies, or logic will be apparent from this disclosure to those of ordinary skill in the art.

With reference to FIG. 5, this figure depicts a block diagram of an example configuration for source record management for master data in accordance with an illustrative embodiment. Application 502 is an example of application 302 in FIG. 3 and operates as a source record management system for source record management for master data 510. Sources 504 and 506 are data sources similar to data sources 131 and 133 in FIG. 1. Match engine 508 is an example of match engine 107 in FIG. 1. Master data 510 is an example of master data 109 in storage 108 in FIG. 1. Source record repository 512 is an example of repository 111 in FIG. 1.

Match engine 508 can be any application or system usable for matching a data record received from a data source to data in master data 510. However, for reasons described above, a data record received from a data source cannot simply be passed to match engine 508. For example, some data records may have to be discarded for reliability, duplicity, or other reasons, before they can be used in a matching operation.

Before a data record can be matched with data in master data 510, application 502 performs pre-match processing using component 514. As an example, in one embodiment, component 514 includes or uses a combination of components 404 and 408 in FIG. 4 to provide functionality 304 for recognizing and treating duplicate records of an entity in a single source's data stream, such as in source 504's data stream.

After the incoming records are pre-processed to reject the duplicates, merge the duplicates, or use the duplicates as-is, component 514 passes the one or more incoming records to match engine 508. Component 514 also records the identifying information about the source of the incoming records, such as source 504, together with a selected subset of the attributes of the pre-processed records into source record repository 512.

Match engine 508 matches the one or more records with master data 510. Match engine 508 may optionally use source record repository 512 for expediting the matching operation.

Furthermore, for reasons described above, even after match engine 508 has performed a matching operation on a data record, some post processing of the record may be needed. For example, some data records may have to be discarded for reliability or age, and some data records may have to be transformed or merged before persisting into master data 510, after they have been used in a matching operation.

After a data record has been matched with data in master data 510, application 502 performs post-match processing using component 516. As an example, in one embodiment, component 516 includes or uses a combination of components 406 and 408 in FIG. 4 to provide functionality 306 for recognizing and treating duplicate records of an entity in multiple sources' data streams, such as in the data streams of source 504 and 506.

After the records from the various sources, such as sources 504 and 506, are processed by match engine 508, component 516 post-processes the records to reject the duplicates, merge the duplicates, use the duplicates as-is, or transform the records. Component 516 also records the identifying information about the sources, such as sources 504 and 506, together with a selected subset of the attributes of the post-processed records into source record repository 512.

As an example, in one embodiment, component 516 applies business rules after a matching operation. An example business rule may dictate that multiple records from a certain combination of sources are not allowed to be matched simultaneously to data in master data 510. Such a rule may be needed when certain sources of data are trusted more than others. Accordingly, component 516 may preclude a first matched record from source 504 from consideration when a second matched record from source 506 is also available. The precluded record is not assigned a key and therefore does not participate in a group, and is not persisted in master data 510.

In another embodiment, instead of precluding the first matched record from source 504, component 516 allows the first matched record to be processed so that component 518 assigns different keys to the first and the second matched records causing the two records to be grouped into different groups. Such post-processing may be useful for match-affinity, whereby different data sources are aligned with different data in master data 510 so that match engine 508 matches the records from a source with only that data in master data 510 with which the source has a match-affinity.

Key assignment component 518 assigns keys to the records that have been post-processed by component 516. The key can be any alphanumeric or symbolic string within the scope of the illustrative embodiments. In one embodiment, component 518 also stores the assigned keys with the corresponding records in source record repository 512.

Component 518 can assign an existing key to a record. For example, in one embodiment, if a new record from source 504 has been successfully matched and post-processed with a previously existing version of the record in master data 510, component 518 assigns the key of the previously existing version of the record to the new record.

As another example, in another embodiment, assume that a new record from source 504 has not been successfully matched with a previously existing version of the record in master data 510. Component 518 assigns a new key to the new record.

In another embodiment, assume that a new record from source 504 has been successfully matched with a previously existing version of the record in master data 510, but post-processing in component 516 indicates that the new record should be assigned a different key. Component 518 assigns a new or different existing key to the new record.

In one embodiment, assume that a new record from source 504 has been successfully matched with a previously existing version of the record in master data 510, but post-processing in component 516 indicates that the new record should be associated with the existing key and other records using the existing key should be assigned a different key. Component 518 assigns the existing key to the new record, re-assigns other records sharing that key to a new or different group by assigning a new or different key.

Component 520 receives the matched, post-processed, key-assigned, and grouped records from application 502. Component 520 or a part thereof can present the information about an entity by using a group of records pertaining to the entity. Component 520 or a part thereof can persist or store the records in master data 510.

In one embodiment, component 520 is an existing application or component configured to operate with application 502. In such an embodiment, instructions for component 520 are located on at least one of the one or more storage devices, such as hard disk drive 226 shown in FIG. 2, and may be loaded into at least one of one or more memories, such as main memory 208 shown in FIG. 2, for execution by processing unit 206 shown in FIG. 2. In another embodiment, component 520 is a part of application 502.

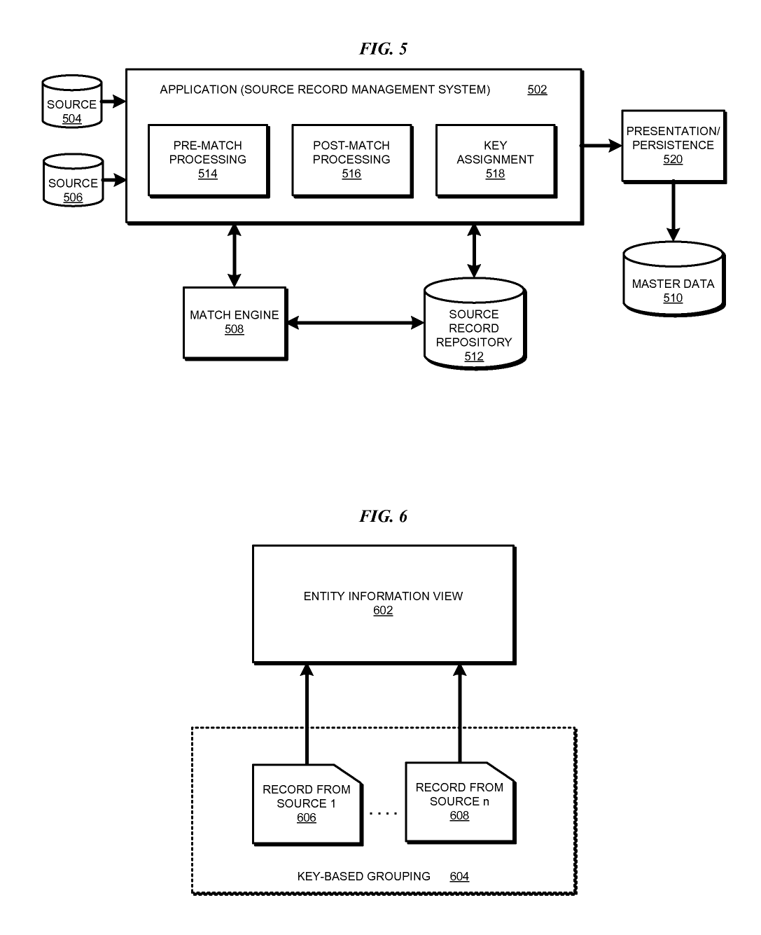

With reference to FIG. 6, this figure depicts a block diagram of presenting entity information using a group of records in accordance with an illustrative embodiment. View 602 can be presented using component 520 in FIG. 5.

View 602 presents information about an entity using key-based grouping 604 of records from one or more data sources. As described with respect to FIG. 5, key-based grouping 604 is constructed in application 502 after pre-processing records from one or more data sources, matching the records with existing master data, post-processing the matched records, and grouping the post-processed records. For example, key-based grouping 604 includes record 606 from “source 1”, through record 608 from “source n” where n is any number suitable for a given implementation, and records 606-608 are any number of records from those n sources.

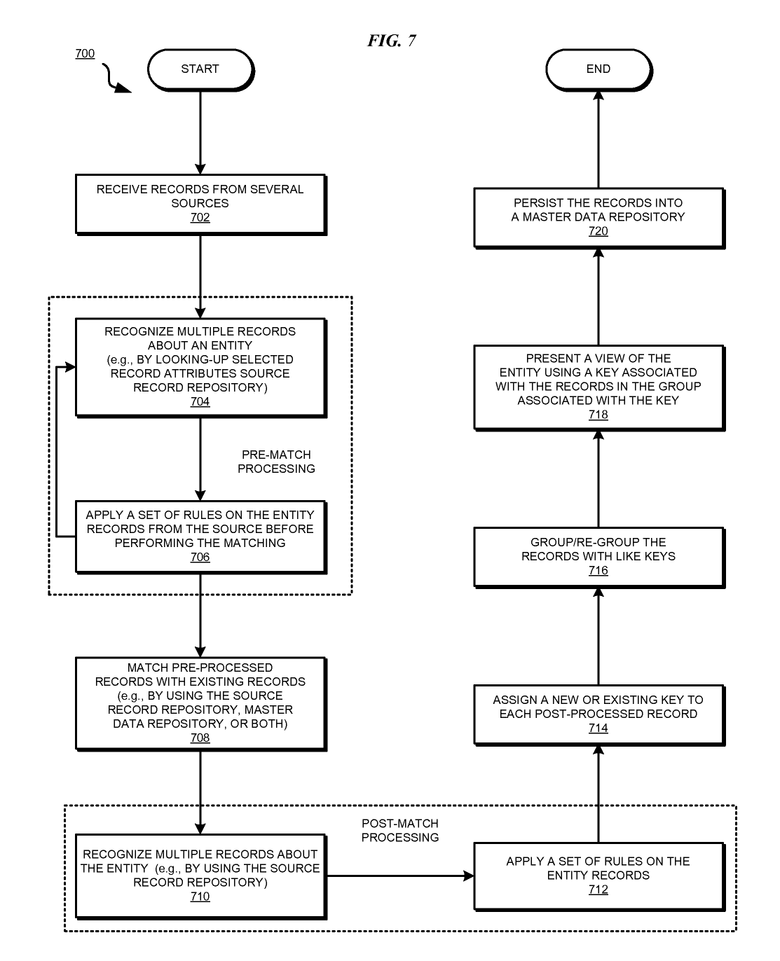

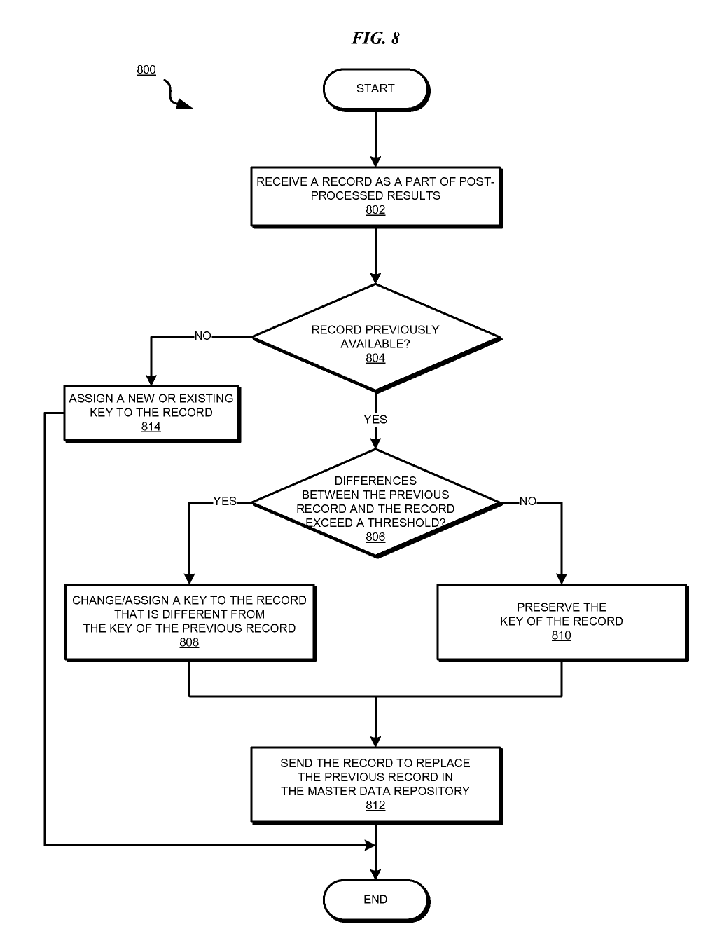

With reference to FIG. 7, this figure depicts a flowchart of an example process for source record management for master data in accordance with an illustrative embodiment. Process 700 can be implemented in a source record management system, such as in application 502 in FIG. 5.

The application receives records from several sources (block 702). In a pre-match processing, such as in component 514 in FIG. 5, the application recognizes multiple records pertaining to an entity (block 704). The multiple records pertaining to the entity can be received from one or more sources at block 702. The application applies a set of rules on the entity records before performing a matching operation with existing master data (block 706).

The application uses a match engine, such as match engine 508 in FIG. 5, to match the pre-processed records with existing records (block 708). For example, the match engine can use source record repository 512 in FIG. 5, master data 510 in FIG. 5, or both, in block 708.

Using the matching results from the match engine, the application performs a post-processing on the records. In the post-match processing, such as in component 516 in FIG. 5, the application recognizes multiple records pertaining to the entity (block 710). The multiple records pertaining to the entity may have been received from one or more sources. The application applies a set of rules on the entity records (block 712).

The application assigns a new or existing key to each post-processed record in the manner described with respect to FIG. 5 (block 714). The application groups or re-groups the records having like keys (block 716).

The application presents a view of the entity using a key associated with the records in the group associated with the entity (block 718). The application persists the records into a master data repository (block 720). Process 700 ends thereafter.

With reference to FIG. 8, this figure depicts a flowchart of an example process of assigning keys to post-processed records in accordance with an illustrative embodiment. Process 800 can be implemented as block 714 in process 700 in FIG. 7.

A key assignment component of a source record management system, such as component 518 in FIG. 5, receives a record about an entity as a part of post-processed results (block 802). The component determines whether a previous version of the record is available in the master data repository (block 804). If the previous version of the record was available (“Yes” path of block 804), the component determines whether the differences between the previous version and the received record exceed a threshold amount or type of difference (block 806).

If the differences exceed the threshold (“Yes” path of block 806), the component changes or assigns a key to the record that is different from the key of the previous version of the record (block 808). Alternatively (not shown), the component changes or assigns a new or different key to other records sharing the key of the previous version, and assigns the key of the previous version to the record. If the differences do not exceed the threshold (“No” path of block 806), the component assigns the key of the previous version of the record to the received record (block 810).

The component sends the record to replace the previous version of the record in the master data repository (block 812). Process 800 ends thereafter.

Returning to block 804, if a previous version is not available (“No” path of block 804), the component assigns a new or existing key to the record (block 814). Process 800 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for source record management for master data. Using an embodiment, master data in a data processing environment can be maintained using data records from various data sources without losing the source identifying information, and without merging different records into a single master data record.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for source record management, the method comprising:
a computer receiving a set of data records from a set of data sources for updating records in a master data repository;
the computer pre-processing a first subset of data records from the set of data records, the first subset of data records being received from a first data source in the set of data sources;
the computer requesting a match engine to match a data record from the first subset of data records using at least one record in the master data repository, the requesting resulting in a set of matched data records;
the computer post-processing the set of matched data records, wherein the set of matched data records includes a first data record in the first subset of data records and a second data record in a second subset of data records from the set of data records, the second subset of data records being received from a second data source in the set of data sources; and
the computer assigning the first data record to a group of records, the group of records and the first data record together representing the entity as a master data record in the master data repository.

2. The method of claim 1, wherein the assigning comprises:
the computer assigning a key to the first data record in the first subset, wherein a second record in the master data record also shares the key with the first data record in the first subset, and wherein the first record in the first subset is not a replacement for the second record in the master data record.

3. The method of claim 1, further comprising:
the computer determining whether the data record from the first subset of data records is a replacement for the at least one record in the master data record of the entity; and
the computer, responsive to the data record from the first subset of data records matching with the at least one record in the master data record within a threshold degree, assigning a key of the at least one record in the master data record to the data record from the first subset of data records, and replacing the at least one record in the master data record with the data record from the first subset of data records.

4. The method of claim 1, further comprising:
the computer determining whether the data record from the first subset of data records is representative of the entity; and
the computer, responsive to the data record from the first subset of data records representing the entity, assigning a new key to the data record from the first subset of data records, the new key being different from a key of the at least one record in the master data record, and forming a second master data record of the entity using the data record from the first subset of data records.

5. The method of claim 1, further comprising:
the computer storing the first data record from the first subset in the master data repository;
the computer storing an attribute of the first data record from the first subset into a source record in a repository;
the computer storing an identifier associated with the first data source with the attribute in the source record in the repository;
the computer storing with the attribute in the source record in the repository a key associated with the group of records; and
the computer using the source record in performing the pre-processing, the requesting, the post-processing, and the assigning.

6. The method of claim 1, wherein the post-processing comprises:
the computer determining whether a first data record in the first subset and a second data record in the second subset describe the entity;
the computer treating, after the matching and responsive to determining that the first data record in the first subset and the second data record in the second subset describe the entity, at least one of the first data record in the first subset and the second data record in the second subset.

7. The method of claim 6, wherein the treating comprises:
the computer preventing the second data record in the second subset from being stored in the master data repository.

8. The method of claim 1, wherein the pre-processing comprises:
the computer determining whether a first data record in the first subset and a second data record in the first subset describes the entity;
the computer treating, responsive to determining that the first and the second data records in the first subset describe the entity, at least one of the first and the second data records in the first subset before matching any of the first data record and the second data record of the first subset with a record about the entity in the master data repository.

9. The method of claim 8, wherein the treating comprises:
the computer preventing the second data record in the first subset from being matched with the record about the entity in the master data repository.

10. A computer program product comprising one or more computer-readable tangible storage devices and computer-readable program instructions which are stored on the one or more storage devices and when executed by one or more processors, perform the method of claim 1.

11. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

12. A computer program product for source record management, the computer program product comprising:
one or more computer-readable tangible storage devices;
program instructions, stored on at least one of the one or more storage devices, to receive a set of data records from a set of data sources for updating records in a master data repository;
program instructions, stored on at least one of the one or more storage devices, to pre-process a first subset of data records from the set of data records, the first subset of data records being received from a first data source in the set of data sources;
program instructions, stored on at least one of the one or more storage devices, to request a match engine to match a data record from the first subset of data records using at least one record in the master data repository, the requesting resulting in a set of matched data records;
program instructions, stored on at least one of the one or more storage devices, to post-process the set of matched data records, wherein the set of matched data records includes a first data record in the first subset of data records and a second data record in a second subset of data records from the set of data records, the second subset of data records being received from a second data source in the set of data sources; and
program instructions, stored on at least one of the one or more storage devices, to assign the first data record to a group of records, the group of records and the first data record together representing the entity as a master data record in the master data repository.

13. The computer program product of claim 12, wherein the program instructions, stored on at least one of the one or more storage devices, to assign comprise:
program instructions, stored on at least one of the one or more storage devices, to assign a key to the first data record in the first subset, wherein a second record in the master data record also shares the key with the first data record in the first subset, and wherein the first record in the first subset is not a replacement for the second record in the master data record.

14. The computer program product of claim 12, further comprising:
program instructions, stored on at least one of the one or more storage devices, to determine whether the data record from the first subset of data records is a replacement for the at least one record in the master data record of the entity; and
program instructions, stored on at least one of the one or more storage devices, to, responsive to the data record from the first subset of data records matching with the at least one record in the master data record within a threshold degree, assign a key of the at least one record in the master data record to the data record from the first subset of data records, and replace the at least one record in the master data record with the data record from the first subset of data records.

15. The computer program product of claim 12, further comprising:
program instructions, stored on at least one of the one or more storage devices, to determine whether the data record from the first subset of data records is representative of the entity; and
program instructions, stored on at least one of the one or more storage devices, to, responsive to the data record from the first subset of data records representing the entity, assign a new key to the data record from the first subset of data records, the new key being different from a key of the at least one record in the master data record, and form a second master data record of the entity using the data record from the first subset of data records.

16. The computer program product of claim 12, further comprising:
program instructions, stored on at least one of the one or more storage devices, to store the first data record from the first subset in the master data repository;
program instructions, stored on at least one of the one or more storage devices, to store an attribute of the first data record from the first subset into a source record in a repository;
program instructions, stored on at least one of the one or more storage devices, to store an identifier associated with the first data source with the attribute in the source record in the repository;
program instructions, stored on at least one of the one or more storage devices, to store with the attribute in the source record in the repository a key associated with the group of records; and
program instructions, stored on at least one of the one or more storage devices, to use the source record in the program instructions to pre-process, request, post-process, and assign.

17. The computer program product of claim 12, wherein the program instructions, stored on at least one of the one or more storage devices, to post-process comprise:
program instructions, stored on at least one of the one or more storage devices, to determine whether a first data record in the first subset and a second data record in the second subset describe the entity;
program instructions, stored on at least one of the one or more storage devices, to treat, after the matching and responsive to determining that the first data record in the first subset and the second data record in the second subset describe the entity, at least one of the first data record in the first subset and the second data record in the second subset.

18. The computer program product of claim 17, wherein the program instructions, stored on at least one of the one or more storage devices, to treat comprise:
program instructions, stored on at least one of the one or more storage devices, to prevent the second data record in the second subset from being stored in the master data repository.

19. The computer program product of claim 12, wherein the program instructions, stored on at least one of the one or more storage devices, to pre-process comprise:
program instructions, stored on at least one of the one or more storage devices, to determine whether a first data record in the first subset and a second data record in the first subset describes the entity;
program instructions, stored on at least one of the one or more storage devices, to treat, responsive to determining that the first and the second data records in the first subset describe the entity, at least one of the first and the second data records in the first subset before matching any of the first data record and the second data record of the first subset with a record about the entity in the master data repository.

20. A computer system for source record management, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to receive a set of data records from a set of data sources for updating records in a master data repository;
program instructions, stored on at least one of the one or more storage devices for execution by at least one of the one or more processors via at least one of the one or more memories, to pre-process a first subset of data records from the set of data records, the first subset of data records being received from a first data source in the set of data sources;
program instructions, stored on at least one of the one or more storage devices for execution by at least one of the one or more processors via at least one of the one or more memories, to request a match engine to match a data record from the first subset of data records using at least one record in the master data repository, the requesting resulting in a set of matched data records;
program instructions, stored on at least one of the one or more storage devices for execution by at least one of the one or more processors via at least one of the one or more memories, to post-process the set of matched data records, wherein the set of matched data records includes a first data record in the first subset of data records and a second data record in a second subset of data records from the set of data records, the second subset of data records being received from a second data source in the set of data sources; and
program instructions, stored on at least one of the one or more storage devices for execution by at least one of the one or more processors via at least one of the one or more memories, to assign the first data record to a group of records, the group of records and the first data record together representing the entity as a master data record in the master data repository.
